(19) United States
(12) Patent Application Publication
(10) Pub. No.: US 2013/0132154 A1
(43) Pub. Date: May 23, 2013

(54) METHOD AND SYSTEM FOR PERFORMING ANALYSIS ON DOCUMENTS RELATED TO VARIOUS TECHNOLOGY FIELDS

(71) Applicant: Anatoly Mayburd, Alexandria, VA (US)

(72) Inventor: Anatoly Mayburd, Alexandria, VA (US)

(73) Assignee: FOUNDATIONIP, LLC, Minneapolis, MN (US)

(21) Appl. No.: 13/512,928

(22) PCT Filed: Dec. 2, 2010
(86) PCT No.: PCT/US10/58667

§ 371 Date: May 31, 2012

Related U.S. Application Data
(60) Provisional application No. 61/266,099, filed on Dec. 2, 2009.

(51) Int. Cl. G06Q 30/02

(52) U.S. Cl. CPC G06Q 30/0202
USPC 705/7.31

(57) ABSTRACT

A method and system for performing an analysis on documents related to one or more aspects of a technology field is provided. The method includes computing a plurality of coefficients from a patent landscape created based on the documents and the one or more aspects of the technology field. The method further includes computing weights for each of the plurality of coefficients using a predefined method. The method further includes calculating a probability score for the one or more aspects using the plurality of coefficients and the weights assigned to each of the plurality of coefficients.

### RELATED APPLICATIONS

This application claims the benefit of priority, under 35 U.S.C. 119(e), to U.S. Provisional Application Ser. No. 61/266,099, filed on Dec. 2, 2009, which is incorporated herein by reference.

### FIELD OF THE INVENTION

This invention generally relates to performing analysis. More specifically, the invention is related to a method and system for performing analysis on documents related to various technology fields.

### BACKGROUND OF THE INVENTION

Performing an analysis to establishing that a product or a service in a technology field may be successful or not is very important. The result of such an analysis can be used by investors in deciding whether to invest or not in a particular product, service, or a technology field for that matter.

In some conventional methods, the prediction of marketing of developing commercial products and the size of the market is accomplished by polling of expert opinions or by access to the insider information. In other conventional methods, company announcements are followed or the development with precedents is compared. However, these methods are purely based on human discretion and thus the result of such methods can be very unreliable.

There is therefore, a requirement for a method and system that uses a machine based method to performing an analysis that has reliable results.

### SUMMARY OF THE INVENTION

In accordance with an aspect of the invention a method of performing an analysis on documents related to one or more aspects of a technology field is provided. The method includes computing a plurality of coefficients from a patent landscape created based on the documents and the one or more aspects of the technology field. The method further includes computing weights for each of the plurality of coefficients using a predefined method. The method further includes calculating a probability score for the one or more aspects using the plurality of coefficients and the weights assigned to each of the plurality of coefficients.

In accordance with another aspect of the invention a system for performing an analysis on documents related to one or more aspects of a technology field is provided. The system includes a processor. The processor is configured to compute a plurality of coefficients from a patent landscape created based on the documents and the one or more aspects of the technology field. The processor is further configured to compute weights to each of the plurality of coefficients using predefined method. The processor is further configured to calculate a probability score for the one or more aspects using the plurality of coefficients and the weights assigned to each of the plurality of coefficients.

In accordance with yet another aspect of the invention, a computer-readable storage medium comprising computer-executable instructions for performing an analysis on documents related to one or more aspects of a technology field is provided. The instructions include computing a plurality of coefficients from a patent landscape created based on the documents and the one or more aspects of the technology field. The instructions further include computing weights to each of the plurality of coefficients using a predefined method. The instructions further include calculating a probability score for the one or more aspects using the plurality of coefficients and the weights assigned to each of the plurality of coefficients.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages.

FIG. 1 is a flowchart of a method for performing an analysis on documents related to one or more aspects of a technology field, in accordance with an embodiment.

FIG. 2 is a flowchart of a method for computing weights for each of a plurality of coefficients, in accordance with an embodiment.

FIG. 3 is a block diagram depicting various components of a system for performing an analysis on documents related to one or more aspects of a technology field, in accordance with an embodiment.

### DETAILED DESCRIPTION

Before describing in detail embodiments, it should be observed that the embodiments reside primarily in combinations of method steps and system components related to methods and systems for performing analysis on documents related to various technology fields. Accordingly, the system components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments provide methods and systems for performing analysis on documents related to various technology fields. The method includes computing a plurality of coefficients from a patent landscape created based on the documents and one or more aspects of a technology field. The one or more aspects of the technology field may include, but are not limited to a company in the technology field, patent subclasses, company portfolios, a product in the technology field, a service in the technology field, a sub-sector within the technology field, and the technology field itself.

The method further includes computing weights for each of the plurality of coefficients using a predefined method. Thereafter, a probability score is calculated for the one or more aspects using the plurality of coefficients and the weights assigned to each of the plurality of coefficients. The probability score may be used as a measure for determining the success or failure of the one or more aspects. For example, a probability score for a product may help in determining its market potential. By way of another example, a probability score for a technology field may enable investors to establish that the technology field does not have a breakthrough potential, and thus should not be ventured into.

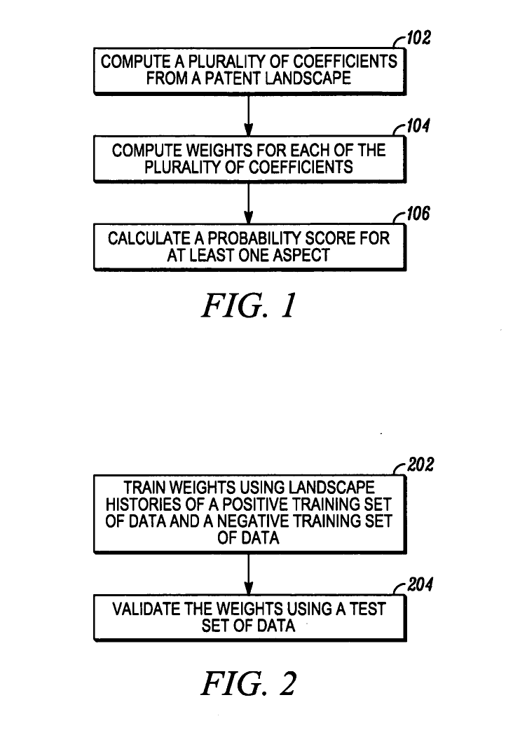

FIG. 1 is a flowchart of a method for performing an analysis on documents related to one or more aspects of a technology field, in accordance with an embodiment. The documents related to the one or more aspects may include, but are not limited to patent documents, financial documents, legal documents other than patent documents, and market research documents.

Based on the documents and the one or more aspects of the technology field a processor creates a patent landscape. In an embodiment, patent documents may be the primary information source for generating the patent landscape and other type of documents may be supplementary information source. The patent landscape for a technology field includes various charts and analysis displaying information that may include but is not limited to different sub-sectors in a technology field, number of assignees in each sub-sectors of the technology field, top assignees having the maximum number of patents, number of patents filed every year in the technology field, backward and forward citations for patents in the technology field.

At step 102, the processor computes a plurality of coefficients from the patent landscape. The plurality of coefficients may include a Capitalization Coefficient (CC). The CC is computed based on one or more factors that include fraction of large scale assignee, fraction of Patent Cooperation Treaty (PCT) publications, and number of patent publications per patent family. The one or more factors may be computed for the one or more aspects of the technology field. Alternatively, the one or more factors may be computed for the technology field.

To ascertain the fraction of large scale assignee, major assignees are identified using the patent landscape. Each assignee which has five or more patents, for example, may be identified as a large scale assignee. Alternatively, a large scale assignee may also be identified by measuring it annual revenue and profits. The presence of large scale assignees in the technology field itself or in a sub-sector within the technology field establishes that there are companies that have the capability of marketing a valuable product or service and follow through a business plan. For this, in an embodiment, a Large-scale Assignee Impact Coefficient (LAIC) is computed by calculating the ratio of publications for a large assignee to the total number of publications in the technology field or in a sub-sector within the technology field. For example, assignee A may have 10 patents in a sub-sector and the total number of patents in the sub-sector may be 40. In this case, LAIC is 10/40, i.e., 0.25.

The second factor for computing the CC, i.e., fraction of Patent Cooperation Treaty (PCT) publications is computed by calculating the ratio of PCT or WIPO publications to the total number of publications in the technology field or in a sub-sector within the technology field. This ratio is termed as WIPO coefficient (WIPOC). For example, if in the technology field there are 20 PCT publications and 40 overall publications, the WIPOC is 20/40, i.e., 0.5. WIPOC enables in measuring interest of large scale investors in the technology field or in the sub-sector. Higher WIPOC indicates the willingness and capability of assignees to invest money in protecting intellectual property in the technology field throughout the world.

Further, the third factor for computing the CC, i.e., number of patent publications per patent family is computed by determining the average number of patents per patent family in the technology field or in a sub-sector within the technology field. This number is termed as Family Size Coefficient (FSC). Similar to WIPOC, FSC indicates willingness and capability of assignees to invest money in protecting intellectual property in the technology field throughout the world. Additionally, it indicates that assignees are interested in investing more to file continuations or divisional to protect and develop an existing idea or product.

The CC may be computed by combining LAIC, WIPOC, and FSC. In an exemplary embodiment, the CC may be computed using equation 1 given below:

CC=FSC+WIPOC+LAIC (1)

Alternatively, the CC may be computed by normalizing and integrating LAIC, WIPOC, and FSC. Since FSC may be any number greater than or equal to 1, and WIPOC and LAIC are fractions that are less than 1, each of these coefficients require normalization. To achieve this, mean CC is computed for a randomized normalizing data set, representing multiple patent classes in various technology fields. In an exemplary embodiment, the mean CC may be computed using equation 2 given below:

CCₘ=[N₁]FSCₘ+[N₂]WIPOCₘ+[N₃]LAICₘ (2)

where,
CCₘ is mean randomized CC computed for multiple patent classes,
FSCₘ is family size coefficient within the normalizing data set,
WIPOCₘ is WIPO coefficient within the normalizing data set,
LAICₘ is LAIC coefficient within the normalizing data set,
N1, N2, N3 are normalizing coefficients derived based on the normalizing data set.

The normalizing coefficients are derived to ensure that each contribution (of FSC, WIPOC and LAIC) is equal. Once the values of N1, N2, N3 are determined within the large-scale normalizing data set, these values are transferred to produce the final value of CC in the given analysis. The CC helps is measuring interest of large scale investors in the technology field or in a sub-sector within the technology field. Additionally, the CC correlates with capitalization and willingness of investors to take a risk in the technology field. Thus, higher the CC, higher would be the success ratio in the technology field for a product or a service.

Additionally, the plurality of coefficients may include a Talent Coefficient (TC). The TC is computed based on one or more factors related to patent assignee companies in the patent landscape. The one or more factors may include sales (A), gross revenue (B), annual growth (C), stock performance (D), award of contracts (E), Earnings Before Interest Taxes Depreciation and Amortization (EBITDA) (F), product recalls (G), negative test results (H), history of complaints (I), and infringement lawsuits (J). All these factor when combined using various methods and combinations determine the TC. For example, the TC may be represented by equation 3 given below:

TC=A+B+C+D+E+F−G−H−I−J (3)

Thus all factors that highlight a positive aspect of an assignee are added and all the factors that highlight a negative aspect for the assignee are subtracted.

The plurality of coefficients further includes Government Support Coefficient (GSC). The GSC is computed based on one or more factors that include presence of US organizations as patent assignees in the patent landscape (K) and inflow of grant money in the technology field (L). The inflow of grant money in the technology field indicates public demand for a service or product in the technology field, maturity of the technology field, and consensus of experts in the technology field. In other words, inflow of grant may predict market success for a product or a service. The GSC may be computed using equation 4 given below:

GSC=K+L (4)

In addition to coefficients discussed above, the plurality of coefficients includes Recent Interest Coefficient (RIC). The RIC is computed based on one or more factors that include median date for patents in the technology field (M) before the date of generating the patent landscape (T), by when a predefined number of patents in the patent landscape were filed. The predefined number, for example, may be 50 percent. For example, the patent landscape was generated on January 20^{th} 2010 (T) and the patent landscape includes 100 patents. To compute M, all the 100 patents may be arranged in order of their filing dates, such that, the patent with earliest filing date is listed on the top and the patent with latest filing date will be listed last. Moving from the patent listed at the last, the date on which 50^{th} patent (counting from the patent listed at the last) was filed is M. The 50^{th} patent may be filed on 20 Jan. 2005. In this case, M is 20 Jan. 2005. RIC may be computed using equation 5 given below:

RIC=0.5/(M−T) (5)

RIC is used to determine changing fundamentals, new understanding, and awakening of public interest in a technology field. Higher RIC for a technology filed or a sub-sector within the technology field indicates more recent interest in the technology field. It will be apparent to a person skilled in the art that various methods of time slicing may be used to compute the RIC.

Further, the plurality of coefficients includes a Litigation Coefficient (LC). The LC is computed based on one or more factors that include citations for patents in a technology field (N), average number of claims per patent in the technology field (O), infringement lawsuits in the technology field (P), total number of patents published in the technology field (Q), and amount of monetary awards received in infringement lawsuits in the technology field (R). The LC may be computed using equation 6 given below:

LC=N+O+P+Q+R (6)

The number of backward citations reflects relevance of the technology field to many existing products or services. Similarly, the number of forward citations indicates that the patent publications play a pivotal role in the technology field as assessed by IP and technical experts. Also, the total number of citations in the technology field reflects competitiveness in the field. Further, the total number of patents in the technology field reflects the integral of capital and research invested in the field.

After computing the plurality of coefficients, the processor computes weights for each of the plurality of coefficients using a predefined method at step 104. This is further explained in conjunction with FIG. 2. Thereafter, at step 106, the processor calculates a probability score for the one or more aspects using the plurality of coefficients and the weights assigned to them. The probability score may be computed using equation 7 given below:

P=[CC]^{W1}[TC]^{W2}[GSC]^{W3}[RIC]^{W4}[LC]^{W5} (7)

where,
P is the probability score,
W1 is the weight assigned to the CC,
W2 is the weight assigned to the TC,
W3 is the weight assigned to the GSC,
W4 is the weight assigned to the RIC,
W5 is the weight assigned to the LC.

The probability score is an indication for success or failure of the one or more aspects of the technology field. For example, a probability score for a product may help in determining its market potential. By way of another example, a probability score for a technology field may enable investors to establish that the technology field does not have a breakthrough potential, and thus should not be ventured into.

FIG. 2 is a flowchart of a method for computing weights for each of a plurality of coefficients, in accordance with an embodiment. After computing the plurality of coefficients, weights are computed for these coefficients. To compute the weights a predefined method is used. To perform the predefine method, at step 202, the processor trains the weights using landscape histories of a positive training set of data and a negative training set of data. The positive training set of data corresponds to positive examples of the technology field and the negative training set of data corresponds to negative examples of the technology field. Positive examples may include, but are not limited to blockbuster products, considerable size and growth of market for a product, drug candidates that passed regulatory control, cars that met requirements of marketability and fuel efficiency, and gadgets that met significant public need generating strong sales. Similarly, negative examples may include, but are not limited to products that failed, products that display small market niche, and products that display stagnant dynamic of sales, drugs with strong side effects that failed clinical trials, cars that fuel inefficient and require costly maintaining, and gadgets that remain unsold in distribution chains.

Thus, the positive training set of data, for example, may be data associated with products that have been very successful in the market and the negative training set of data, for example, may be data associated with products that have not been so successful in the market. Thereafter, the values for the weights are chosen, such that, there is an optimal separation between the probability scores computed for the positive training set of data and the negative training set of data. At step 204, the processor validates the weights using a test set of data. The testing set is prepared before creating the patent landscape and is used only for final validation.

In an embodiment, the positive training set of data is smaller than and is a fraction of the negative training set of data. In this case, the value of probability scores computed for the positive training set of data may be treated as normal distribution outliers in the total population of the positive training set of data and the negative training set of data. Further, Z scores of normal distribution are maximized for the positive training set of data, and the plurality of coefficients provided to achieve this may be used as the actual working plurality of coefficients.

In another embodiment, the negative training set of data and the positive training set of data may be separated by generating an automatic landscape study. The automatic landscape study may be sub-divided into a plurality of sectors. One or more of the plurality of sectors include positive examples of technologies, for example, blockbuster drug classes. For each sector a probability score using the equation 7 may be computed. The weights assigned to the plurality of coefficients are not given any value initially. For sectors with positive examples, the weights are assigned a preliminary value of 1 and probability scores are computed for each of the plurality of sectors based on this. The vector of the probability scores is then converted into a vector of Z scores. Thereafter, the weights are modified.

The Z score for a successful sector within the plurality of sectors become an outlier of normal distribution. The extent of outlying depends on the structure of the vector for the weights. Each modification of vector for the weights may lead to increase in the Z score of the successful sector. In an embodiment, the plurality of sectors may include a set of successful sectors. In this case, the sum of Z scores for the set of successful sectors may be maximized by modifying vector for the weights. To achieve this, the weights are modified starting with the left side of the equation (7). For example, W1 is modified first followed by W2, W3, W4, and W5. The weights may become fractional or negative.

After achieving a local maximum of the successful sector's or the set of successful sectors' Z score with W1, the next coefficient W2 is modified by the same protocol until Z score or relevant sum of the Z scores stops to increase. If modification of any weight fails to increase Z score for the successful sector or the set of successful sectors, that particular weight is left intact and the next weight is modified. As a result, the vector for the weights is trained to identify the sectors that resemble the already established successful sectors in their primary components. A sector that does not display a strong marketable product, but approaches an established successful sector in terms of Z score may be considered promising based on the method discussed above.

It will be apparent to a person skilled in the art that other methods that include but are not limited to Neural Networks, Support Vector Machines, Decision Trees, and Methods of Centroids may be used to compute the weights.

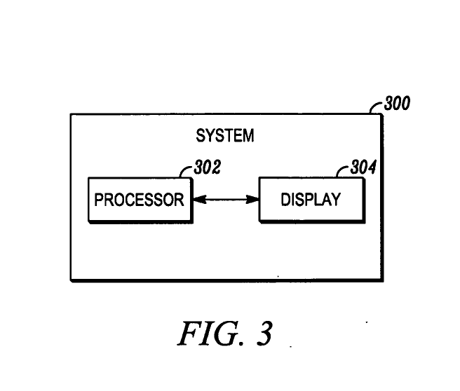

FIG. 3 is a block diagrams depicting various components of a system 300 for performing an analysis on documents related to one or more aspects of a technology field, in accordance with an embodiment. System 300 includes a processor 302 and a display 304. Processor 302 computes a plurality of coefficients from a patent landscape created based on the documents and the one or more aspects of the technology field. Thereafter, processor 302 computes weights for each of the plurality of coefficients using a predefined method. Processor 302 then calculates a probability score for the one or more aspects using the plurality of coefficients and the weights assigned to each of the plurality of coefficients. This has been explained in detail in conjunction with FIGS. 1 and 2. Display 304 displays the computation of the plurality of coefficients and the probability score.

Various embodiments provide methods and systems for performing analysis on documents related to various technology fields. In this method, the landscaping procedures rely on computation of the same parameters and on combining of such parameters in a supervised regression model which is trainable by fitting to the patent histories of the best or the worst commercial products. The probability score can be used to weed out the technologies which do not have a breakthrough potential. Additionally, the probability score would help in identifying the technologies with maximal potential. Such a capability can be extremely useful for investors, project managers and government planners. Further, as this method is automatic it can be coupled with landscape browsing software.

Those skilled in the art will realize that the above recognized advantages and other advantages described herein are merely exemplary and are not meant to be a complete rendering of all of the advantages of the various embodiments.

The method for performing analysis on documents related to various technology fields as described or any of its components may be embodied in the form of a computing device. The computing device can be, for example, but not limited to, a computer, a programmed microprocessor, a micro-controller, a peripheral integrated circuit element, and other devices or arrangements of devices, which are capable of implementing the steps that constitute the method.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of performing an analysis on documents related to at least one aspect of a technology field, the method comprising:
computing a plurality of coefficients from a patent landscape created based on the documents and the at least one aspect of the technology field;
computing weights for each of the plurality of coefficients using a predefined method; and
calculating a probability score for the at least one aspect using the plurality of coefficients and the weights assigned to each of the plurality of coefficients.

2. The method of claim 1, wherein the documents comprise patent documents, financial documents, legal documents, and market research documents.

3. The method of claim 1, wherein the at least one aspect comprises a company in the technology field, patent subclasses, company portfolios, a product in the technology field, a service in the technology field, a sub-sector of the technology field, and the technology field.

4. The method of claim 1, wherein the plurality of coefficients comprises a Capitalization Coefficient (CC), the CC being computed based on one or more factors comprising fraction of large scale assignees in the technology field, fraction of Patent Co-operation Treat (PCT) publications in the technology field, and number of patent publication per patent family in the technology field.

5. The method of claim 1, wherein the plurality of coefficients comprises a Talent Coefficient (TC), the TC being computed based on one or more factors related to patent assignee companies in the patent landscape, the one or more factors comprising sales, gross revenue, annual growth, stock performance, award of contracts, product recalls, negative test results, history of complaints, and infringement lawsuits.

6. The method of claim 1, wherein the plurality of coefficients comprises a Government Support Coefficient (GSC), the GSC being computed based on one or more factors comprising presence of US organizations as patent assignees in the patent landscape and inflow of grant money in the technology field.

7. The method of claim 1, wherein the plurality of coefficients comprises a Recent Interest Coefficient (RIC), the RIC being computed based one or more factors comprising median date for patents in the technology field before the date of generating the patent landscape by when a predefined number of patents in the patent landscape were filed.

8. The method of claim 7, wherein RIC comprises 0.5/(M−T), wherein M is median date for patents in the technology field before the date of generating the patent landscape by when fifty percent of patents in the patent landscape were filed and T is the date of generating the patent landscape.

9. The method of claim 1, wherein the plurality of coefficients comprises a Litigation Coefficient (LC), the LC being computed based on one or more factors comprising citations for patents in the technology field, number of patents in the technology field, average number of claims per patent in the technology field, infringement lawsuits in the technology field, and amount of monetary awards received in infringement lawsuits in the technology field.

10. The method of claim 1, wherein the predefined method comprises:
training the weights using landscape histories of a positive training set of data and a negative training set of data, wherein the positive training set of data corresponds to positive examples of the technology field and the negative training set of data corresponds to negative examples of the technology field; and
validating the weights using a test set of data.

11. The method of claim 10, wherein the positive training set of data is a fraction of the negative training set of data, the positive training set of data being smaller than the negative training set of data.

12. A system for performing an analysis on documents related to at least one aspect of a technology field, the system comprising:
a processor configured to:
compute a plurality of coefficients from a patent landscape created based on the documents and the at least one aspect of the technology field;
compute weights to each of the plurality of coefficients using predefined method; and
calculate a probability score for the at least one aspect using the plurality of coefficients and the weights assigned to each of the plurality of coefficients.

13. The system of claim 12, wherein the plurality of coefficients comprises a Capitalization Coefficient (CC), the CC being computed based on one or more factors comprising fraction of large scale assignee in the technology field, fraction of WIPO publications in the technology field, and number of patent publication per family of patent in the technology field.

14. The system of claim 12, wherein the plurality of coefficients comprises a Talent Coefficient (TC), the TC being computed based on one or more factors related to patent assignee companies in the patent landscape, the one or more factors comprising sales, gross revenue, annual growth, stock performance, award of contracts, product recalls, negative test results, history of complaints, and infringement lawsuits.

15. The system of claim 12, wherein the plurality of coefficients comprises a Government Support Coefficient (GSC), the GSC being computed based on one or more factors comprising presence of US organizations as patent assignees in the patent landscape and inflow of grant money in the technology field.

16. The system of claim 12, wherein the plurality of coefficients comprises a Recent Interest Coefficient (RIC), the RIC being computed based one or more factors comprising median date for patents in the technology field before the date of generating the patent landscape by when a predefined number of patents in the patent landscape were filed.

17. The system of claim 12, wherein RIC comprises 0.5/(M−T), wherein M is median date for patents in the technology field before the date of generating the patent landscape by when fifty percent of patents in the patent landscape were filed and T is the date of generating the patent landscape.

18. The system of claim 12, wherein the plurality of coefficients comprises a Litigation Coefficient (LC), the LC being computed based on one or more factors comprising citations for patents in the technology field, number of patents in the technology field average number of claims per patent in the technology field, infringement lawsuits in the technology field, and amount of monetary awards received in infringement lawsuits in the technology field.

19. The system of claim 12, wherein the predefined method comprises:
training the weights using landscape histories of a positive training set of data and a negative training set of data, wherein the positive training set of data corresponds to positive examples of the technology field and the negative training set of data corresponds to negative examples of the technology field; and
validating the weights using a test set of data.

20. The system of claim 12 further comprises a display configured to display computation of the plurality of coefficients and the probability score.

21. A computer-readable storage medium comprising computer-executable instructions for performing an analysis on documents related to at least one aspect of a technology field, the instructions comprising:
computing a plurality of coefficients from a patent landscape created based on the documents and the at least one aspect of the technology field;
computing weights to each of the plurality of coefficients using predefined method; and
calculating a probability score for the at least one aspect using the plurality of coefficients and the weights assigned to each of the plurality of coefficients.
